(19) United States
(12) Patent Application Publication
(10) Pub. No.: US 2009/0309898 A1
(43) Pub. Date: Dec. 17, 2009

(54) RENDERING APPARATUS AND METHOD

(76) Inventors: Norihiro NAKAMURA, Kawasaki-shi (JP); Yoshiyuki Kokojima, Yokohama-shi (JP); Isao Mihara, Tokyo (JP); Yasunobu Yamauchi, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/409,276

(22) Filed: Mar. 23, 2009

(30) Foreign Application Priority Data
Jun. 12, 2008 (JP) 2008-154414

(51) Int. Cl. G06T 11/20; G09G 5/00

(52) U.S. Cl. 345/647; 345/442; 345/619; 382/167

(57) ABSTRACT

The rendering parameters including the position coordinate, the color information and the transparency in a vector definition space are calculated for each pixel occupied by a curved surface model projected on a screen. Plural primitive data are generated and stored from the vector data. By judging whether the plural primitive data include the position coordinate or not, a rendering judgment variable is determined, and in the case where the rendering judgment variable is added an odd number of times, the raster data of the pixel corresponding to the position coordinate is generated based on the rendering parameters.

### CROSS-REFERENCE TO RELATED APPLICATIONS

This application is based upon and claims the benefit of priority from prior Japanese Patent Application No. 2008-154414, filed Jun. 12, 2008, the entire contents of which are incorporated herein by reference.

### BACKGROUND OF THE INVENTION

1. Field of the Invention

This invention relates to a rendering apparatus and a rendering method for rendering a vector pattern.

2. Description of the Related Art

The image formed by combining geometric pattern elements such as dots, curves, rectangle and ellipses is called the vector graphics. On the other hand, the image formed by arrangement of points (pixels or dots) is called the raster graphics.

Generally, the image displayed on a display unit and the image printed on a printer are raster graphics. In handling the vector graphics with these devices, the process of converting the vector graphics to the raster graphics (rasterization) is required. The rasterization is an expensive process, and a high-performance computer is required to rasterize the complicated vector graphics. In the vector graphics, however, the raster graphics of the proper resolution can be generated each time of display, and therefore, the image quality such as the contour line is not adversely affected by enlargement, compression or deformation of the image. As a result, the artificial images having a clear contour line such as illustrations and diagrams are often handled as the vector graphics. The natural images such photos, on the other hand, are often handled as the raster graphics.

The application of the vector graphics most familiar in our life is the font. The computer in the early stage of development used to employ the font of raster type (bit map font) due to the limited CPU performance, and the need to hold the font data for each resolution required a large storage capacity. With the subsequent improvement in CPU performance, the computer in current use can hold the font (outline font) data of vector type not dependent on the resolution, and by generating the font of proper resolution commensurate with the display and the printer each time, the font high in quality can always be displayed with a small storage capacity. Even so, the problem still remains that the CPU built in the mobile phone and the car navigation system has a comparatively low processing capacity and the operation cost required to rasterize the vector graphics has yet to be reduced.

To obviate this problem, GPU (graphic processor unit) has recently been used positively. A method for rasterizing the pattern formed of lines and curves has already been proposed (JP-A 2006-106705).

Also, a method capable of quick rasterization even in the case where the pattern graphics changes dynamically is known (JP-A 2007-304871).

### BRIEF SUMMARY OF THE INVENTION

According to one aspect of the present invention, a rendering apparatus comprising: a first storage unit which stores vector data indicating an arbitrary pattern; a second storage unit which stores a curved surface model as a guide for rendering of the pattern; a first calculation unit which defines the pattern independently of the curved surface model for each pixel occupied by the curved surface model projected on a screen and which calculates a rendering parameter including a position coordinate, a color information and a transparency in a vector definition space accessed to determine an attribute value of the pixel; a first generating unit which generates a plurality of primitive data based on one of a linear contour and a curved contour by analyzing the vector data along a contour line; a third storage unit which stores the plurality of the primitive data in the vector definition space; a judging unit which judges whether the plurality of the primitive data include the position coordinate, which adds a rendering judgment variable of the position coordinate in the case where the primitive data including the position coordinate is that of the linear contour, and which adds the rendering judgment variable in the case where the primitive data including the position coordinate is that of the curved contour and the position coordinate is included in a convex area of the curved contour; and a second generating unit which generates the attribute value of the pixel corresponding to the position coordinate based on the rendering parameter in the case where the rendering judgment variable is added an odd number of times.

### BRIEF DESCRIPTION OF THE SEVERAL VIEWS OF THE DRAWING

FIG. 1 is a block diagram showing a rendering apparatus using a triangular data as a rendering control primitive data according to a first embodiment.

FIG. 2 is a diagram showing an example of the pattern of vector type.

FIG. 3 is a diagram showing an example of the vector data.

FIG. 4 is a flowchart showing the steps of the process executed by a rendering attribute control information calculation unit according to the first embodiment.

FIG. 5 is a diagram showing an example of the area generated based on a rendering judgment variable.

FIG. 6 is a block diagram showing a rendering apparatus according to a second embodiment.

FIG. 7 is a block diagram showing a rendering apparatus according to a modification 1 of the second embodiment.

FIG. 8 is a block diagram showing a rendering apparatus according to a third embodiment.

FIG. 9 is a flowchart showing an outline of the process according to the third embodiment.

FIG. 10 is a flowchart showing the steps of the process executed by a sampling point calculation unit according to the third embodiment.

FIG. 11 is a flowchart showing the steps of the process executed by a rendering attribute control information recalculation unit according to the third embodiment.

FIG. 12 is a flowchart showing the detail of the steps of the process executed by the rendering attribute control information recalculation unit according to the third embodiment.

FIG. 13 is a flowchart showing the steps of the rasterization process according a comparative example.

FIGS. 14A and 14B are diagrams showing an example of a linear contour and a curved contour.

FIGS. 15A and 15B are diagrams showing an example of the pattern formed of a triangle generated from the curved contour and the curved contour.

FIGS. 16A and 16B are diagrams showing an example of the curved contour subdivided and the linear contour updated correspondingly.

FIG. 17 is a diagram showing the linear contour divided into triangles.

FIGS. 18A and 18B are diagrams showing an example of the linear contour and the curved contour rasterized according to the comparative example.

FIG. 19 is a diagram showing an example of the raster data generated by the comparative example FIG. 20 is a diagram showing an example of the linear contour.

FIG. 21 is a diagram showing an example of the triangular data generated from the linear contour according to a comparative example.

FIG. 22 is a diagram showing an example of the point numbers of the triangles generated by the linear contour according to the comparative example.

### DETAILED DESCRIPTION OF THE INVENTION

Embodiments of the invention are explained below with reference to the drawings.

### (First Embodiment) “Curved Surface Rendering not Requiring Pre-Processing and Subdivision”

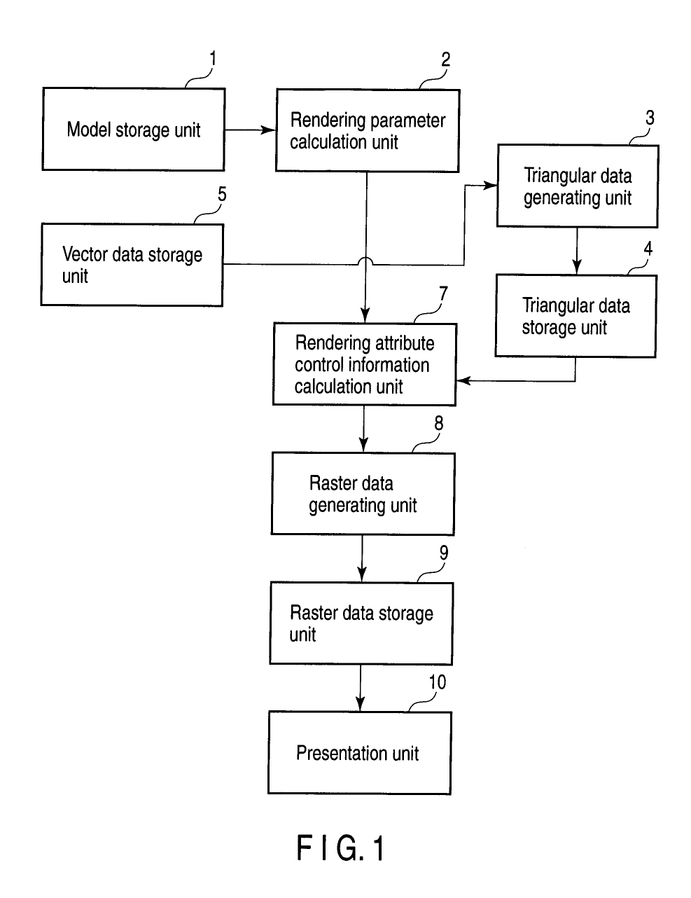

As shown in FIG. 1, the rendering apparatus according to a first embodiment includes a model storage unit 1 used as a guide for rendering a vector pattern to store a curved surface model (hereinafter referred to as the “curved surface”) with the vector data rendered thereon and a vector definition position where a vector pattern is rendered, a vector data storage unit 5 for storing the pattern data of vector type indicating an arbitrary pattern (hereinafter referred to as “the vector data”), a rendering parameter calculation unit 2 supplied with the data on the curved surface and the vector data definition position from the model storage unit 1 to calculate the rendering parameters such as the position coordinate (for example, the texture coordinate) based on the curved surface corresponding to each pixel making up the rendering result, a triangular data generating unit (rendering control primitive data generating unit) 3 wherein the vector data held in the vector data storage unit 5 are read and the primitive data typically including a triangle or a convex polygon used for rendering the vector data are generated in the vector definition space which is independent of the space defining the curved surface and which defines the vector data to be rendered with a unique position coordinate (or a texture coordinate), a triangular data storage unit (rendering control primitive data storage unit) 4 for storing the triangular data generated by the triangular data generating unit 3, a rendering attribute control information calculation unit 7 for calculating the judgment information to judge how to render each pixel of the raster data having the resolution determined in accordance with the detail of the requested input data, using the corresponding position obtained in the rendering parameter calculation unit 2 and the primitive data (for example, the triangle) stored in the triangular data storage unit 4, and a raster data generating unit 8 for judging whether a particular pixel is to be rendered, using the judgment information obtained from the rendering attribute control information calculation unit 7, determining the color information and the alpha value and outputting the raster data.

The result output from the raster data generating unit 8 may be held in a raster data storage unit 9 in the form of an image generally used in the graphics field such as the bit map, JPEG or GIF or may be output to a presentation unit 10 such as the display or the printer. Also, the output result or the data held may be transferred through a network.

The model storage unit 1, the vector data storage unit 5 and the triangular data storage unit 4, though depicted as different blocks in FIG. 1, may alternatively be configured collectively on a single memory or dividedly on different plural memories.

Also, according to this embodiment, the vector definition space is assumed to be a two-dimensional space with each axis defined in the range of, for example, 0 to 1. Nevertheless, the vector definition space is not limited to this form, and each axis may be defined in other range except 0 to 1 or as a three-dimensional space.

This embodiment is first explained with reference to an example in which the rendering control primitive data is a triangle as shown in FIG. 1. A case in which a pattern other than the triangle is used for the rendering control primitive data is described later.

The detailed operation of each block and the structure of the data flowing between the blocks of the rendering apparatus shown in FIG. 1 are explained sequentially with reference to the diagrams.

### [Model Storage Unit 1]

The model storage unit 1 stores therein the curved surface of which the rendering of the vector data held in the vector data storage unit 5 is desired and the position (vector data definition position) indicating which position on the curved surface the rendering is desired. Incidentally, the data held in the model storage unit 1 is not limited to these data, but may include other information generally used for rendering in the graphics field such as the camera parameters indicating the position of the eye point and the direction of the eye vector, and the orthographic projection or the perspective projection, whichever is desired to use.

### [Vector Data Storage Unit 5]

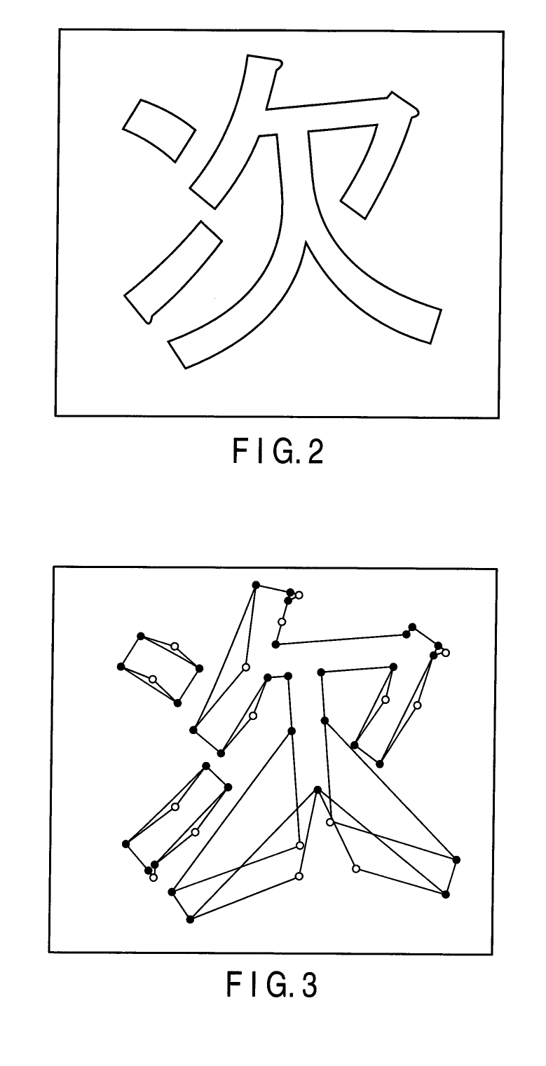

The vector data storage unit 5 stores therein the vector data of the pattern to be rasterized. The vector data has the type of the pattern elements, the coordinate of each point making up the pattern elements and the connection between the points. The vector data of the pattern shown in FIG. 2, for example, is as shown in FIG. 3. In FIG. 3, each end point of the line or the curve is indicated by a black circle, each control point of the curve by a white circle. According to this embodiment, these vector data are stored in the vector data storage unit 5 in advance.

Incidentally, the vector data is not limited to the form described above, but may include other data used generally in the field of graphics such as the color information and the alpha value.

### [Rendering Parameter Calculation Unit 2]

In the rendering parameter calculation unit 2, the rendering parameters including the position coordinate, the color information and the transparency in the vector definition space are calculated for each pixel occupied by the curved surface model at the time of projecting the curved surface on the screen. The vector definition space is referred to not only to define the vector data to be rendered independently of the curved surface, but also to determine the pixel attribute value.

Specifically, at the time of rendering the vector data held in the vector data storage unit 5, the rendering parameter calculation unit 2 reads, from the model storage unit 1, the vector data definition position, i.e. the position of rendering the curved surface data and the vector data together with, if required, the camera parameters and the projection method, and calculates the parameters indicating which position of the vector definition space corresponds to each pixel of the raster data output from the raster data generating unit 8 and what color is defined. As a result, the pixel attribute information including the position coordinate of each pixel in the vector definition space (hereinafter referred to as “the corresponding position”), the color information and the transparency of each pixel are determined.

According to this embodiment, the texture coordinate, for example, is used as the parameter corresponding to the vector definition space. In the case where the texture coordinate is used, the correspondence with the vector definition space is calculated using the texture mapping technique generally used in the graphics field thereby to calculate the position in the vector definition space.

The corresponding position (such as the texture coordinate), the color information of each pixel and the transparency can be calculated in the same way as the curved surface is rendered. For example, the curved surface is approximated by a mass of minuscule triangular surfaces and a particular triangular surface which determines the attribute information of each pixel is calculated. This calculation method is the same as the method of determining the pixel attribute information at the time of rendering the triangular surface, which is generally employed in the graphics field and therefore not described any further. Also, the method of determining the pixel attribute information from the curved surface is not limited to the aforementioned method. For example, a half line is extended from each pixel along the line of sight at the time of rendering to employ the position corresponding to the intersection between the curved surface and the half line (such as the texture coordinate), the color information and the transparency as the pixel attribute information. Also, the invention limited neither to this method can employ any other methods capable of calculating the pixel attribute information for each pixel.

The information corresponding to the vector definition space is not limited to the form described above, but other data generally used in the graphics field may be used or included. Also, the corresponding information may be an independently defined value which may be substituted into a predetermined equation as a parameter. Further, the parameter such as the curvature calculated from the curved surface may be used and changed.

### [Triangular Data Generating Unit 3]

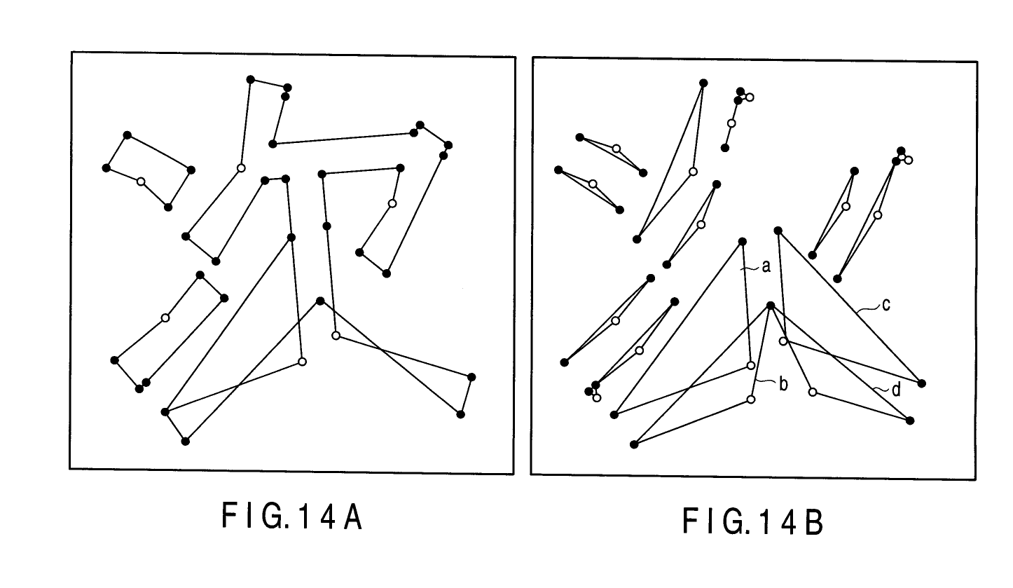

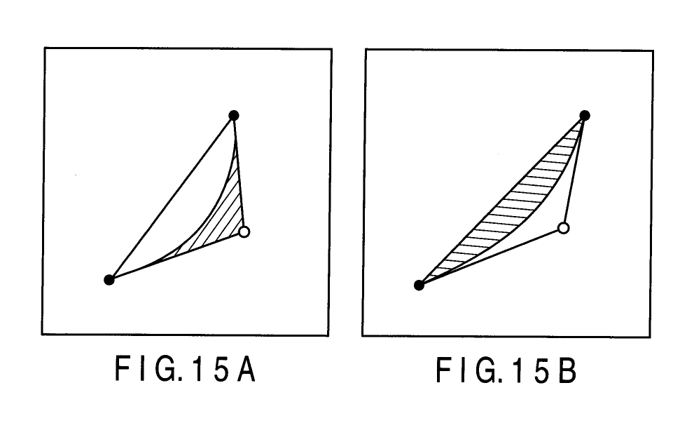

The triangular data generating unit 3 reads the vector data (FIG. 3) held in the vector data storage unit 1 and executes the process of generating the triangular data by analyzing the contour line thereof. The part regarded as a curve as the result of analyzing the contour line (hereinafter referred to as “the curved contour” constitutes a triangle with a starting point, a control point and an ending point. In the process, as indicated in the area painted over in black in FIG. 15B, only the convex area of the curve defined inside the triangle makes up the pattern. Also, one arbitrary point is selected from a polygon defined by the contour formed of only lines generated by tracing the contour line of the vector data and connecting the points other than the control point in the order of appearance (hereinafter referred to as “the linear contour”) thereby to generate a group of triangles formed of the particular one point and the edge lines of the polygon. The method disclosed in JP-A 2007-304871 described above, for example, can be used to generate the triangular data from the vector data. Nevertheless, the method of generating the triangular data is not limited to this method. Specifically, a triangle is formed of the starting point, the control point and the ending point on the curved contour while at the same time selecting an arbitrary point from the polygon defined by all the points including the control point thereby to generate group of triangles formed of the particular one point and the edge lines of the polygon. In this case, the triangles formed of the curved contour line are of two types, one in which a pattern is indicated by the convex area of the curve defined inside as shown in FIG. 15B and the other in which a pattern is indicated by the concave area as shown in FIG. 15A. Also, the linear contour is defined as the result of tracing the contour line of the vector data and connecting all the points in the order of appearance. This process of generation can use, for example, the method disclosed in JP-A 2006-106705 described above. The triangular data is a space independent of the space defining the curved surface as described above, and defined by the vector definition space defining the vector data to be rendered by the independent position coordinate (the texture coordinate in the case under consideration). In this case, all the triangular data are included in the vector definition space and normalized in such a manner as to the maximize the size of each triangle. For example, all the group of the triangular data generated in the triangular data generating unit 3 are included, and by considering a minimum rectangle with each side thereof parallel to any axis of the vector definition space, the rectangle is normalized at the magnification rate for enlargement in the range included in the vector definition space while maintaining the aspect ratio of the particular rectangle. Nevertheless, the invention is not limited to this method, but any other normalization method generally used in the graphics field may be employed.

### [Triangular Data Storage Unit 4]

The triangular data storage unit 4 stores therein the triangular data generated by the triangular data generating unit 3.

### [Rendering Attribute Control Information Calculation Unit 7]

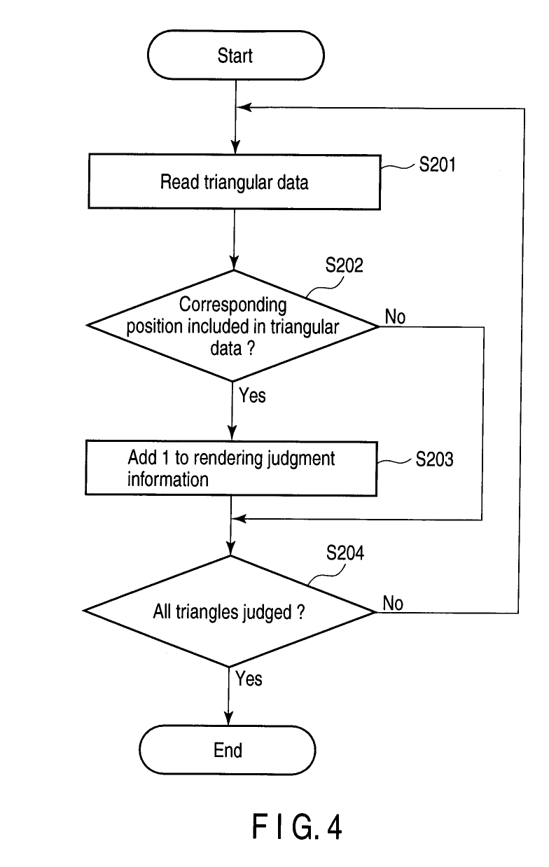

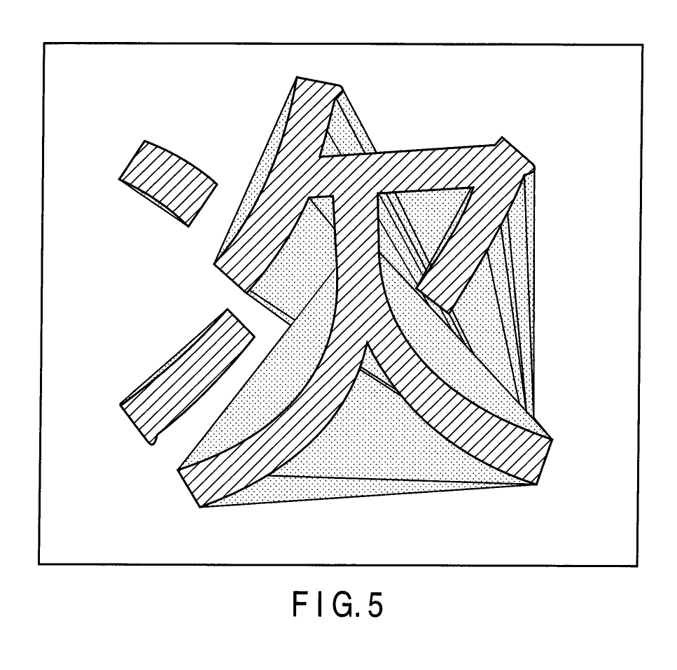

The rendering attribute control information calculation unit 7, by referring to the triangular data stored in the triangular data storage unit 4 and the result of calculation in the rendering parameter calculation nit 2, calculates the information for judging whether the corresponding position is included in the closed area formed of the vector data. The flowchart of this process is shown in FIG. 4.

In the first step S201, one triangle never read thus far in step S201 is read from the triangular data constituting a mass of triangles generated from the linear contour and the curved contour. The next step S202 checks whether the triangular data or a part of the triangular data includes the corresponding position calculated by the rendering parameter calculation unit 2 or not. In the case where the triangle read in step S201 is the triangle generated from the linear contour, 1 is added to the rendering judgment variable if the corresponding position is included in the particular triangle. In the case of the triangle generated from the curved contour, on the other hand, the process executed is varied depending on the generation rule in the triangular data generating unit 3.

The first condition to be met, which is a common rule regardless of the generation rule, is that the situation is true in the case where the corresponding position is included in the triangle.

The second condition to be met is varied depending on the generation rule for the triangular data. In the case of the triangle configured in such a manner that only the convex area of the curved line indicates the pattern as shown in FIG. 15B, the condition is true if the corresponding position is included in the convex area of the curved line. In the case where the pattern is configured of two types, one with the pattern indicated by the convex area defined inside as shown in FIG. 15B and the other with the pattern indicated by the concave area indicating the pattern as shown in FIG. 15A, on the other hand, the condition is true if the corresponding position is included in the convex area of the convex curve (the curve with the pattern indicated by the convex area of the curved line) or the concave area of the concave curve (the curve with the pattern indicated by the concave area of the curved line), as the case may be. In the case where these two conditions are both true, 1 is added to the rendering judgment variable in step S203.

The process of steps S201 to S203 is repeated until all the triangular data are judged thereby to obtain the number of times the corresponding position is judged as included in the triangular data or a part thereof. According to this embodiment, this value is used as the rendering judgment variable.

In the case where the triangular data is formed of the triangles generated from three linear contours and the corresponding positions are equivalent to the interior of two of the triangles, for example, the rendering judgment variable is 2. Also, the vector data holds the information such as the color information and the alpha value, which may be calculated at the corresponding position if required.

### [Raster Data Generating Unit 8]

The raster data generating unit 8, by referring to the rendering judgment variable calculated in the rendering attribute control information calculation unit 7, determines and outputs whether each pixel is written in the raster data for screen display using the pixel attribute information already calculated, i.e. whether the rendering is carried out or not for each pixel. Only in the case where the rendering judgment variable is an odd number, the pixel is written in the raster data. In the process, in the case where there is the color information or the alpha value calculated from the vector data, the corresponding part of the color information or the alpha value of the pixel attribute information already calculated is replaced by the value calculated from the vector data, or alternatively, may be blended with the color information or the alpha value included in the pixel attribute information already calculated. The fact that the rendering judgment variable is an odd number is equivalent to the fact that the entire area in the pattern of the curved line defined by the triangular data generated from the linear contour and the triangular data generated from the curved contour is rasterized by writing the particular pixel an odd number of times. This is described in JP-A 2007-304871. In terms of generation of the stencil data, the aforementioned fact is equivalent to the fact that the stencil data bit is inverted an odd number of times to assume a value other than 0 and judged as the interior of the pattern. The gray (hatched) parts in FIG. 5 are where the pixel is written an even number of times, and the black parts are where it is written an odd number of times. In other words, the result similar to the stencil data of JP-A 2007-304871 can be obtained.

### [Raster Data Storage Unit 9]

The raster data storage unit 9 stores the raster data generated by the raster data generating unit 8.

The raster data is an image data having the same resolution as the resolution finally presented to the presentation unit 10. The invention, however, is not limited to this type of the raster data structure but may include other data generally used in the graphics field.

### [Presentation Unit 10]

The presentation unit 10 is configured of a display and a printer for presenting the raster data held in the raster data storage unit 9 to the user.

### [Summarization]

In the rendering apparatus according to this embodiment, the pattern expressed in vector data can be rendered on the curved surface. In view of the fact that the triangular data used to render the pattern is maintained in the vector definition space in the rendering process, regenerating the triangular data is not required even in the case where the pattern geometric changes dynamically and quick rendering can be executed.

### Modification 1 of First Embodiment

The vector data, though divided into triangular data in the first embodiment, may alternatively be divided into plural different polygons (convex polygonal data formed of four points or more) by replacing the triangular data generating unit 3 and the triangular data storage unit 4 with a convex polygonal data generating unit and a convex polygonal data storage unit, respectively.

### [Convex Polygonal Data Generating Unit]

In the convex polygonal data generating unit, the vector data held in the vector data storage unit 5 are divided into convex polygons with the total number of the sides of thereof smaller than the total number of the sides of the particular triangles so that the group of the triangles generated by the triangular data generating unit 3 are allowed to be superposed one on another. For example, those triangles which are on the same plane generated by the triangular data generating unit 3 from the linear contours and share the edge lines of the triangles and which form no concave polygon if merged are merged (combined) with each other. The convex polygon thus generated is further merged with another triangle as far as the conditions described above are satisfied. In similar fashion, any set of convex polygons are merged with each other if the aforementioned conditions are met.

The judgment as to whether the triangles are on the same plane or not can be made by judging whether the normals to the triangles, the convex polygons or the combination of the triangles and the convex polygons point the same direction. Incidentally, an arbitrary vertex of the triangle or the convex polygon is selected and three points from that point are selected counterclockwise, so that two edge lines formed of the three points are specified and the outer product of the two edge lines is calculated to determine the normals. Also, the judgment as to whether a polygon is a concave one or not can be made by checking whether all the angles inside the polygon are less than 180 degrees. How to determine such angles is a common process in the graphics field and therefore not explained. The dividing method, the method of judging whether the triangles are on the same plane or not and the judgment as to whether a polygon is a concave one are not limited to the methods described above and any other methods generally used in the graphics field may be used.

### [Convex Polygonal Data Storage Unit]

The convex polygonal data storage unit stores the convex polygonal data generated in the convex polygonal data generating unit.

In the modification 1, the rendering attribute control information calculation unit 7 checks whether the corresponding position is included in the polygonal data or not. Typically, the judgment as to whether a given position coordinate is included in a convex polygon having more sides than the triangle is made by calculating the outer product of the edge lines of the polygon and the position coordinate and checking the sign of the value of the calculation result. In the case where the vector data is divided into a convex polygon, the number of the edge lines of the plural convex polygons generated is smaller than the number of the triangular data, and therefore, the cost of the process of judging the interior or exterior in the rendering attribute control information calculation unit 7 is reduced. In the case where the dynamic deformation of the pattern results in a concave polygon, on the other hand, the polygon is required to continue to be divided until the particular polygon transforms into a convex polygon.

### [Summarization]

According to this modification, the vector pattern can be rendered on the curved surface by quicker rasterization than in the first embodiment. In the case of dynamic deformation of the pattern, however, the convex polygon is required to be corrected. In the case where the dynamic deformation of the pattern is needed, therefore, the method of the first embodiment should be used.

### Modification 2 of First Embodiment

According to the first embodiment, the rendering attribute control information calculation unit 7 judges the interior or exterior of the triangular data and the corresponding position, and the raster data generating unit 8 generates the raster data only by judging whether each pixel is written in the raster data. The modification 2, on the other hand, is different in that the rendering attribute control information calculation unit 7 calculates and outputs also the information other than the result of the interior/exterior judgment by the rendering attribute control information calculation unit 7 at the same time, and the pixel which the raster data generating unit 8 judges to be written is processed using the information other than the interior/exterior judgment result calculated by the rendering attribute control information calculation unit 7.

### [Rendering Attribute Control Information Calculation Unit 7]

The rendering attribute control information calculation unit 7 according to this modification is different in that the information for the process to be executed by the raster data generating unit 8 is calculated in addition to the rendering judgment variable.

For example, those edge lines of the triangular data held in the triangular data storage unit 4 which share the edge lines of the original vector data or the shortest distance from the corresponding position is determined to the curved line of the triangular data. This process is not limited to the calculation of the shortest distance but may include the parameters used in the graphics field other than the distance. Also, the shortest distance is not necessarily determined but may be replaced with the parameter other than the shortest distance.

### [Raster Data Generating Unit 8]

The raster data generating unit 8 according to this modification, in addition to the function of the raster data generating unit 8 according to the first embodiment, includes an image processing function with the additional information calculated by the rendering attribute control information calculation unit 7 as a parameter. For example, the shortest distance normalized in the range of 0 to 1 is held for the alpha value of the pixels with the shortest distance of a predetermined value or less calculated by the rendering attribute control information calculation unit 7. Incidentally, the shortest distance is not necessarily normalized to 0 to 1. Also, the additional information is not necessarily the shortest distance as explained above.

### [Summarization]

According to this modification, the edge portion of the pattern of the rendering raster data is blurred, the color is blended with the approach to the edge or otherwise the rendering is effectively carried out using the accurate vector data.

### (Second Embodiment) “Rendering with Vector Data Dynamically Deformable”

Next, a second embodiment of the invention is explained.

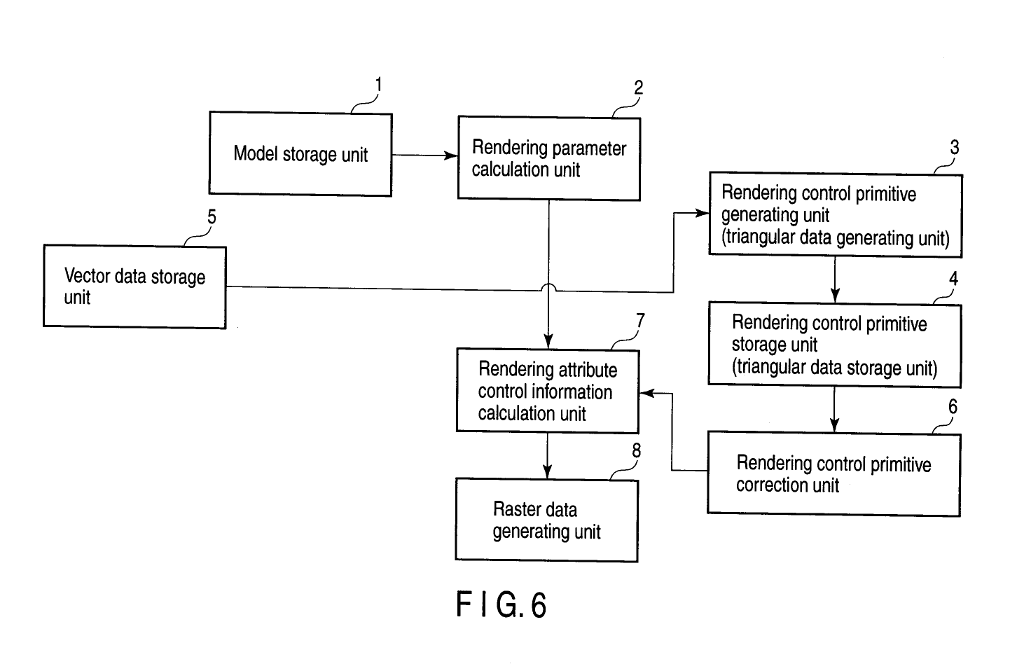

FIG. 6 is a block diagram showing the rendering apparatus according to the second embodiment. As understood from FIG. 6, the feature of this embodiment lies in that the rendering control primitive data correcting unit 6 is added to the configuration of the first embodiment.

Now, an explanation is given below as in the first embodiment assuming that the rendering control primitive data is a triangle.

According to the first embodiment, the triangular data generating unit 3 is operated in such a manner as to carry out the normalization to define as large a triangular data as possible in the vector definition space. According to the second embodiment, on the other hand, the dynamic deformation is made possible without changing the data stored in the triangular data storage unit 4 by making the appropriate correction in the rendering control primitive data correcting unit 6. By reducing the triangular data with the control primitive data correction unit 6, for example, the vector data output can be reduced without changing the vector definition position held in the model storage unit 1. This operation can be performed by carrying out the affine transform against the triangular data obtained by accessing the triangular data storage unit 4. Also, the rotation and the transfer can rotate and move, respectively, each vector data. This operation is also possible by the affine transform generally employed in the graphics field. Further, the correction by vertex unit is possible similarly by affine transform of the vertex. The correction by vertex unit makes it possible to corrugate the vector data or produce other effects without changing the vector definition position held in the model storage unit 1. Also, the modifications described above may be combined for correction, and the correction according to the invention is not limited to the modifications described above. As long as the topology is not disrupted, the operation of vector data modification generally employed in the graphics field can be carried out.

Parameters such as the magnification rate, the rotational angle, the transfer amount to carry out these correction steps may be either added to a model or be input from an external source as the transfer amount and numerical values of the mouse. As another alternative, only the correction parameters may be applied as data.

Also, the convex polygon shown in the modification 1 of the first embodiment can be processed similarly as far as the correction result is a convex polygonal data.

In the case where the correction result is a concave polygon, on the other hand, the concave polygon is divided repeatedly until the concave polygon transforms into a convex polygon. As an example, a convex polygon is divided into a set of triangles and then converted into convex polygons by the method similar to the one employed by the convex polygonal data generating unit. Nevertheless, the method of dividing a concave polygon into plural convex polygons is not limited to the method described above, and any other method generally used in the graphics field may be used.

### [Summarization]

According to this embodiment, the primitive data held in the triangular data storage unit are not changed, and therefore, the vector data can be modified without regenerating the rendering control primitive data. As a result, the processing speed is increased.

### Modification 1 of Second Embodiment

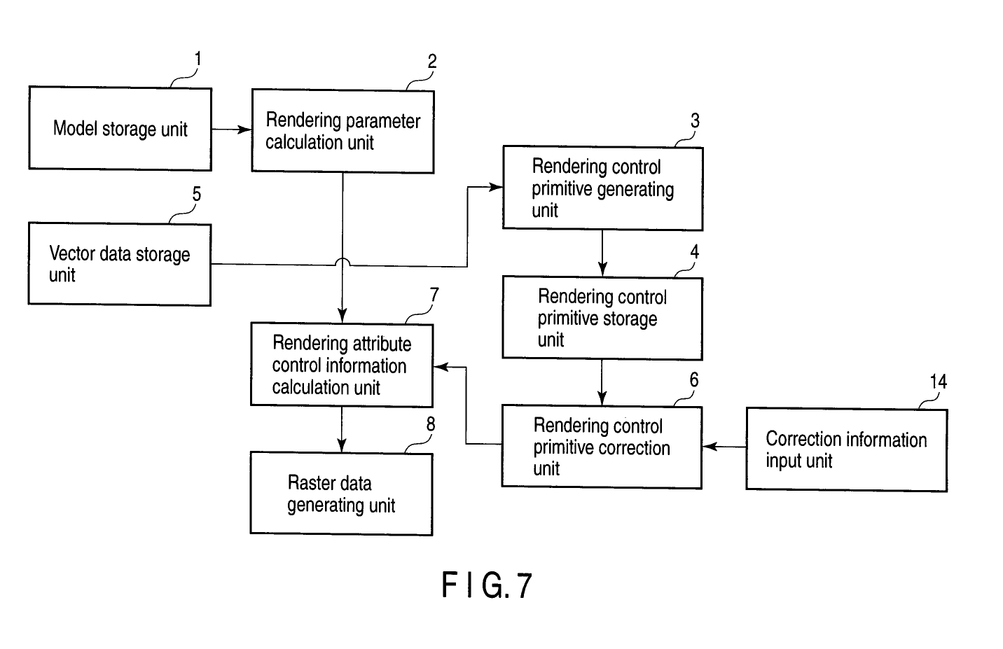

FIG. 7 is a block diagram showing the modification 1 of the second embodiment. As understood from FIG. 7, this modification is different in that the correction information input unit 14 is included in the second embodiment. According to the second embodiment, the correction parameter is given in advance to the rendering control primitive data correcting unit 6. In this modification, on the other hand, input is dynamically applied from an external source by the correction information input unit 14 and corrected each time.

### [Correction Information Input Unit 14]

The correction information input unit 14, accepting the input of the user operation constantly or at predetermined sampling intervals, processes and outputs the input values as correction parameters to the rendering control primitive data correcting unit 6. For example, the difference between the immediately preceding position and the present position of the mouse is calculated, and the result is multiplied by a predetermined magnification. The figure thus obtained is used as a magnification rate in the rendering control primitive data correction unit 6. In the case where the value multiplied is not a magnification rate but an angle, the rotational angle is obtained, or by multiplying an arbitrary value, the amount obtained can be regarded as a translation amount. The input device is not limited to the mouse, nor the method of using the parameter not limited to the aforementioned case. Also, the magnification rate, the rotational angle and the transfer amount may be calculated by another alternative method.

### [Summarization]

According to this modification, the quickly deformed vector data can be rendered on the curved surface in accordance with the user input operation.

### (Third Embodiment) “Antialiasing Requiring no Alpha Blend”

Next, a third embodiment of the invention is explained.

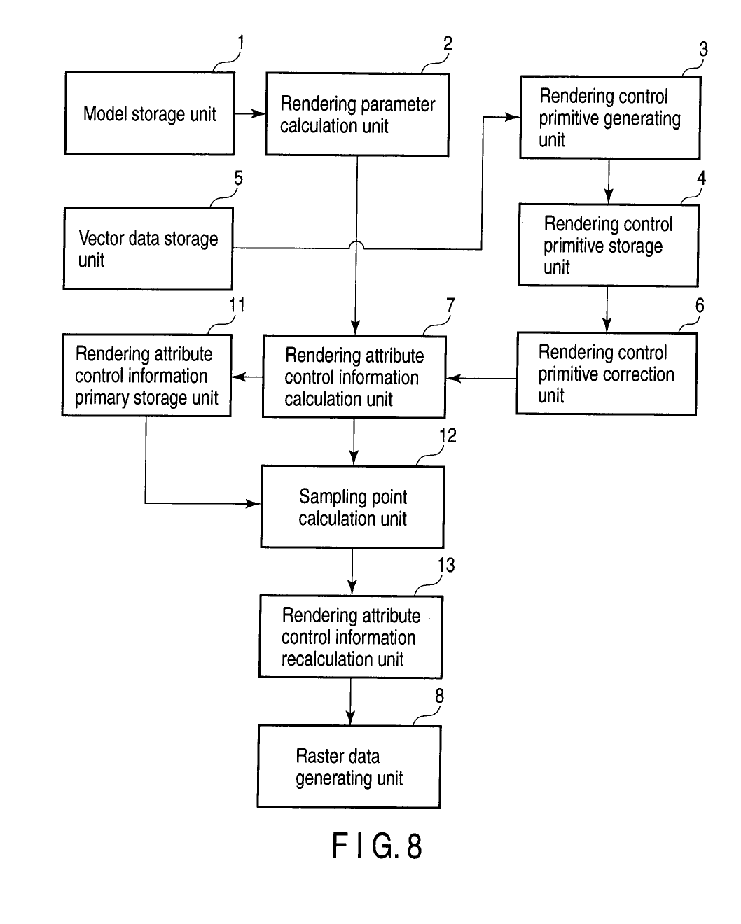

FIG. 8 is a block diagram showing the rendering apparatus according to the third embodiment. As understood from FIG. 8, the feature of this embodiment lies in that a rendering attribute control information primary storage unit 11, a sampling point calculation unit 12 and a rendering attribute control information recalculation unit 13 are added to the configuration of the second embodiment.

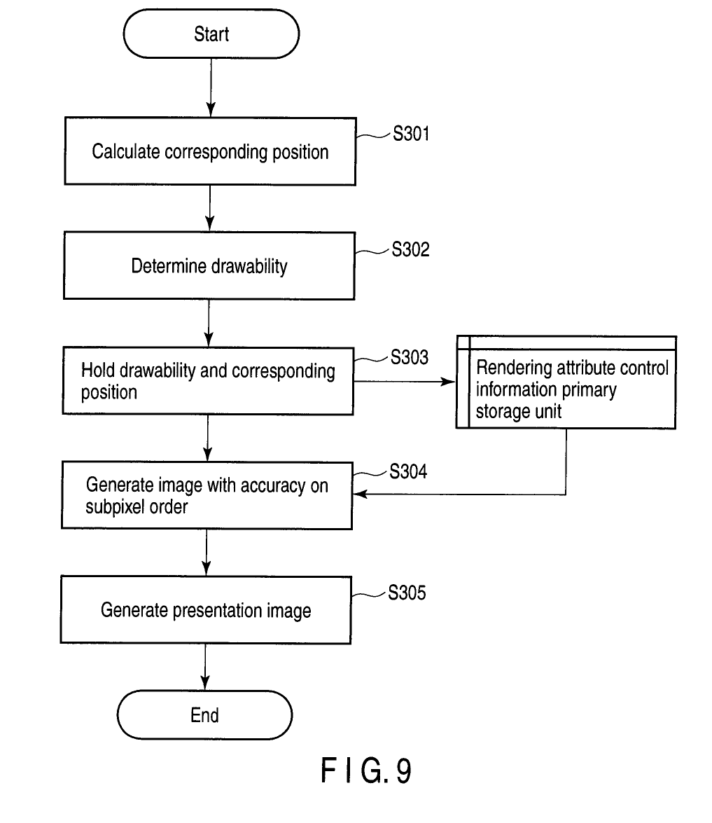

FIG. 9 shows an outline of the process executed according to the third embodiment. The process of steps S301 and S302 is similar to that of the method according to the first embodiment. Based on the rendering judgment variable calculated by the rendering attribute control information calculation unit 7, the drawability in units of pixel is judged by the process similar to the drawability judgment in the raster data generating unit 8. The process of step S302 and subsequent steps is different from the first embodiment. According to the second embodiment, the image having the accuracy on subpixel order is generated in step S304 based on the result of step S302 and the corresponding position in step S301 and, after being processed to the accuracy on pixel order in step S305, output to the presentation unit 10. In the process, the antialiasing requiring no alpha blend is realized by carrying out the method of image generation with the accuracy on subpixel order in step S304 without using the algorithm such as the Z sort dependent on the sequence in the processing method of step S305.

Incidentally, in FIG. 8, the model storage unit 1, the vector data storage unit 5, the triangular data storage unit 4 and the rendering attribute control information primary storage unit 11 are designated as different blocks. Nevertheless, these component parts may be either collectively configured on a single memory or distributively on plural different memories.

### [Rendering Attribute Control Information Calculation Unit 7]

The rendering attribute control information calculation unit 7 according to this embodiment, in addition to the process of the rendering attribute control information calculation unit 7 according to the first embodiment, executes the process of judging whether each pixel is to be written in the rendering raster data or not, with reference to the calculated rendering judgment variable. The judgment method is similar to the one executed in the raster data generating unit 8 according to the first embodiment, but without writing directly in the output raster data, the antialiasing process is further executed.

### [Rendering Attribute Control Information Primary Storage Unit 11]

In the rendering attribute control information primary storage unit 11, the drawability calculated in the rendering attribute control information calculation unit 7 and the corresponding position used for judgment thereof are held in such a form as to be accessible by pixel. For example, the image color may be held in any one of or over plural elements RGBA. Nevertheless, the image color may be held by other than this method. For example, a method is also available in which the indexes of the longitudinal and lateral sides of the image, the drawability and the corresponding position are stored in a set. Apart from this method, any method can be used in which the drawability and the corresponding position are uniquely determined by pixel.

### [Sampling Point Calculation Unit 12]

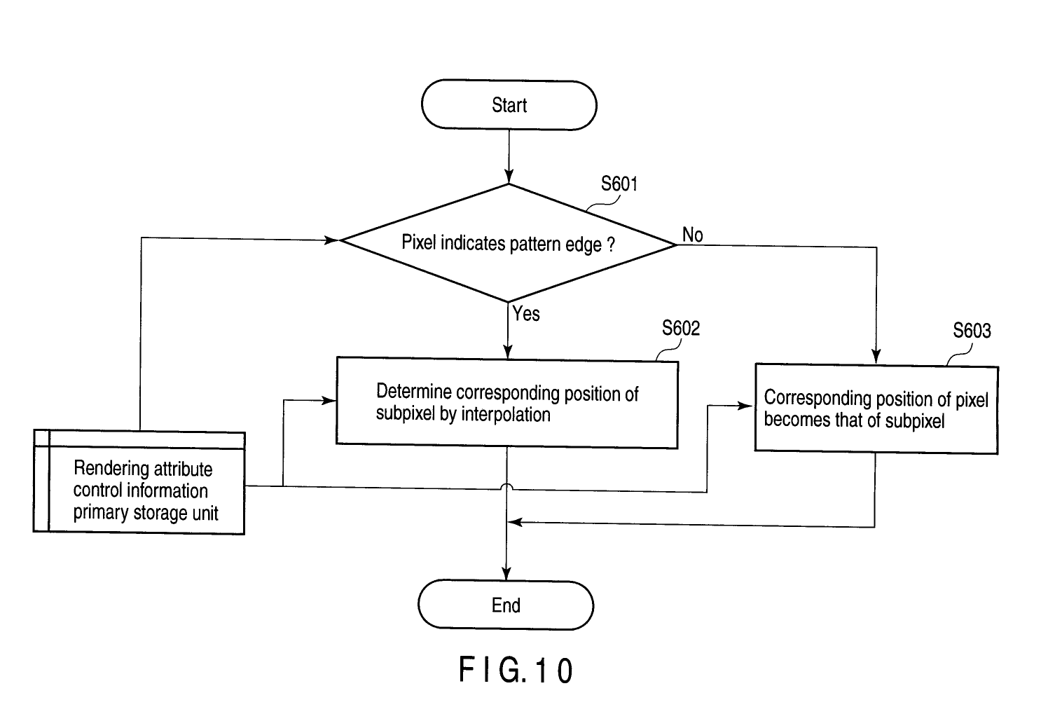

As shown in FIG. 10, with reference to the drawability and the corresponding position held in the rendering attribute control information primary storage unit 11, the corresponding position for determining the drawability is calculated with the accuracy on subpixel order for the subpixels of the pixels indicating the pattern edges.

First, step S601, with reference to the drawability held in the rendering attribute control information primary storage unit 11, judges whether the pixel indicates the edge of the pattern. In the case where the pixel indicates the edge, the process proceeds to step S602 for calculating the position corresponding to the subpixel. Otherwise, the process proceeds to step S603, so that the corresponding position of the subpixel is identical with the corresponding position of the original pixel.

Step S601 is to reduce the calculation amount of the rendering attribute control information recalculation unit 13, and the judgment is not always necessary in step S601. In all the cases where no judgment is made, the process proceeds to step S602.

According to this embodiment, the corresponding position of the subpixel in step S602 is calculated by interpolation between the position corresponding to the adjoining pixel and the position corresponding to the pixel indicating the pattern edge. An example of the interpolation method is to determine the linear interpolation with the corresponding position of the adjoining pixels. Nevertheless, the invention is not limited to this method, and the nonlinear interpolation may be used with the curvature of the curved surface or any other method generally used in the graphics field.

### [Rendering Attribute Control Information Recalculation Unit 13]

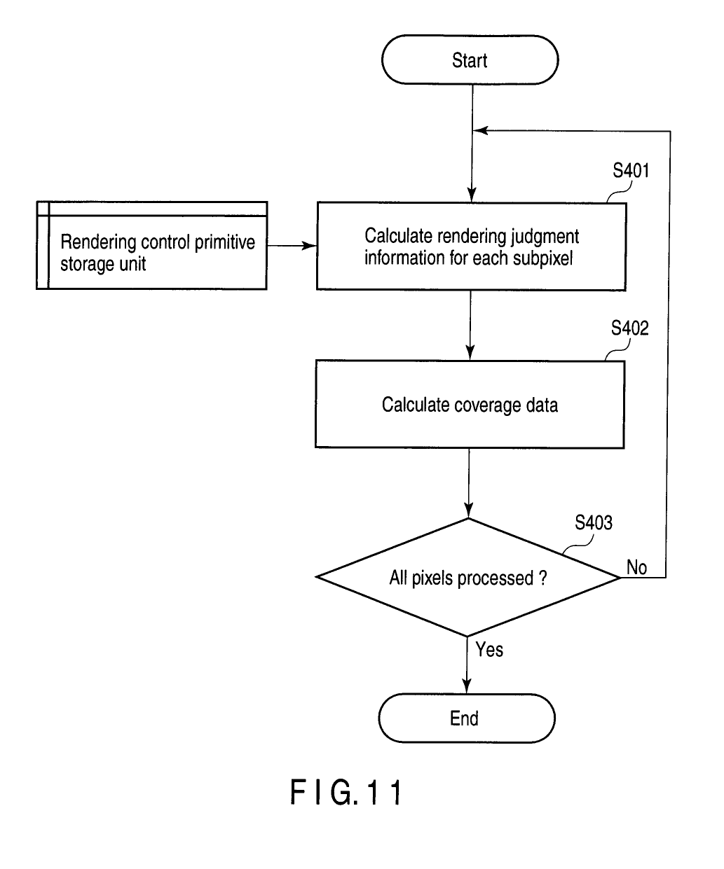

As shown in FIG. 11, the drawability at the corresponding position for each subpixel calculated in the sampling point calculation unit 12 is judged to determine the drawability with the accuracy on subpixel order. The drawability is calculated by the method employed in the raster data generating unit 8 which judges the drawability on subpixel order.

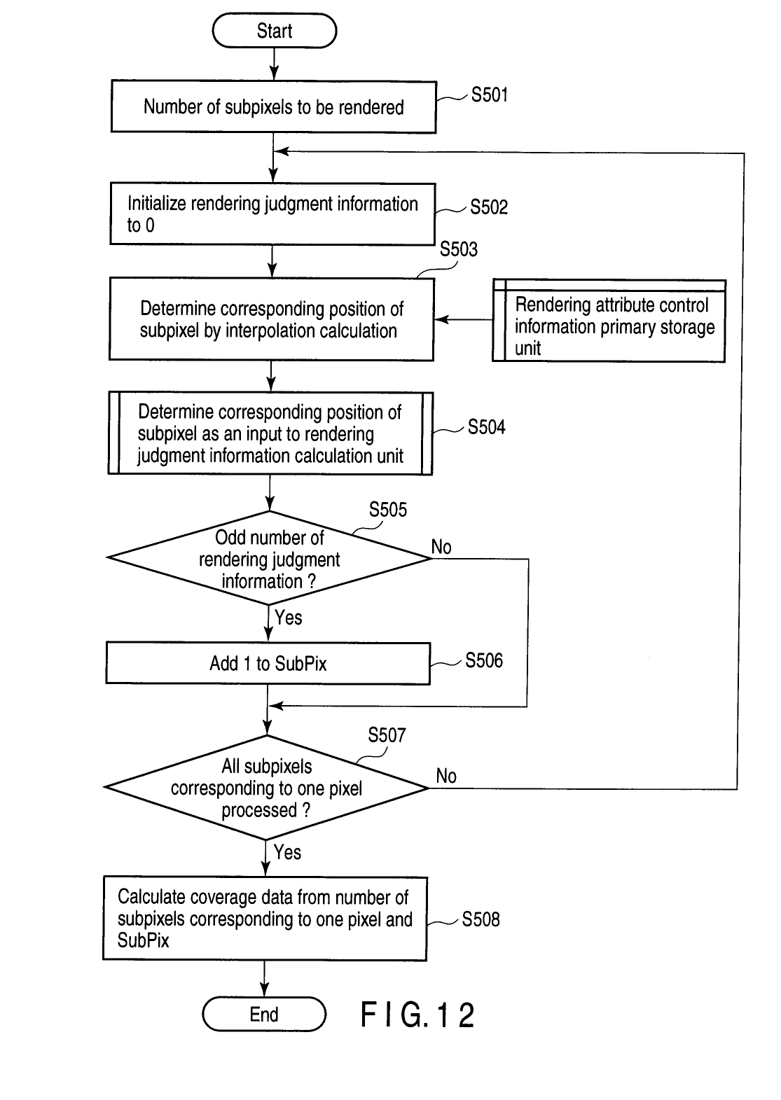

The input is the corresponding position for each subpixel output from the sampling point calculation unit 12. In step S401, the rendering judgment variable for each subpixel is calculated with the corresponding position of each subpixel as input. Based on the result of S401, step S402 calculates the coverage data indicating the degree to which the original pixel divided into subpixels is drawable. The coverage data is determined from the ratio between the number of subpixels corresponding to a particular pixel and the number of the subpixels judged as writable. FIG. 12 is a diagram showing steps S401 and S402 in more detail. S401 corresponds to S501 to S507, and S402 corresponds to S508.

In the case where the particular pixel is not the one indicating the edge of the pattern, however, the rendering judgment variable is not calculated for each subpixel and the coverage data of the pixel is determined as unity.

### [Raster Data Generating Unit 8]

The raster data generating unit 8 according to this embodiment is supplied with the coverage data calculated in the rendering attribute control information recalculation unit 13 and the pixel attribute information calculated in the rendering parameter calculation unit 2 to generate the raster data with the accuracy on subpixel order. The coverage data and the raster data are synthesized thereby to generate the raster data with accuracy on pixel order which is stored in the raster data storage unit 9. In the case where the pixel is rasterized with the coverage data as unity, the color value of the currently rasterized pixel is assigned to all the subpixels included in the particular pixel. In the case where the pixel with the coverage data smaller than unity, i.e. the pixel in the neighborhood of the pattern edge is rasterized, on the other hand, the color value of the currently rasterized pixel is assigned to a part of the subpixels included in the particular pixel, while the color value already assigned to the remaining subpixels is held as it is. Incidentally, the subpixel assigned the color value is selected based on the size of the coverage.

By synthesizing the raster data with the accuracy on subpixel order, a smooth rasterization result free of jaggies is obtained.

### [Summarization]

As described later, JP-A 2006-106705, for example, uses the alpha blend for antialiasing, and therefore, all the patterns are required to be depth sought and rasterized sequentially from those in the depth first. The rendering apparatus according to this embodiment, on the other hand, is configured free of the alpha blend high in processing cost, and can perform the antialiasing operation at high speed.

### Modification 1 of Third Embodiment

According to the third embodiment, the coverage data is generated by analyzing the edge part of the rasterized pattern with the accuracy on subpixel order, and the antialiasing operation realized using the coverage data thus generated. This modification is different from the third embodiment in the coverage data generating method. Specifically, the difference lies in that the additional information obtained in the rendering attribute control information calculation unit 7 according to the modification 2 of the first embodiment is used as the coverage data calculated in the rendering attribute control information recalculation unit 13 according to the third embodiment.

The block diagram of this modification is a combination of the block diagrams according to the modification 2 of the first embodiment and the third embodiment. The functions up to the rendering attribute control information calculation unit 7 are included in the block diagram of the modification 2 of the first embodiment, while the subsequent functions are associated with the blocks including and subsequent to the rendering attribute control information recalculation unit 13 in the block diagram of the second embodiment. Specifically, the feature of this modification resides in that the rendering attribute control information recalculation unit 13 of the third embodiment is arranged before the raster data generating unit 8 according to the modification 2 of the first embodiment. Those function blocks added in the third embodiment which have different functions than that of the third embodiment are described below.

### [Rendering Attribute Control Information Recalculation Unit 13]

Those of the additional information calculated in the rendering attribute control information calculation unit 7 according to the modification 2 of the first embodiment which are a threshold value or less are normalized to 0 and 1 and output. The additional information exceeding the threshold value are output as 1.

### [Summarization]

This modification is different from the third embodiment in the coverage calculation method, and like the third embodiment, can perform the antialiasing operation quickly without using the alpha blend high in processing cost. Also, the use of the accurate vector data for calculation of the coverage data can produce the result higher in accuracy. Depending on the type of the additional information calculated in the rendering attribute control information calculation unit 7, however, the processing cost may increase beyond that of the third embodiment.

As explained above, the rendering apparatus according to the embodiments of the invention makes possible a quick rasterization even in the case where the rendering of a deformed pattern is desired on a curved surface. Also, the quick rasterization is realized even in the case where the pattern geometry is dynamically changed. Further, the quick antialiasing operation is possible without using the alpha blend high in processing cost.

### COMPARATIVE EXAMPLE

The techniques described in JP-A 2006-106705 and JP-A 2007-304871 are explained below as comparative examples of the embodiments of the invention.

In order to reduce the operation cost required for rasterization of the vector graphics, the GPU (graphics processor unit) is used as described above. First, an explanation is given about the technique described in JP-A 2006-106705 to rasterize the pattern formed of lines and curves as shown in FIG. 2.

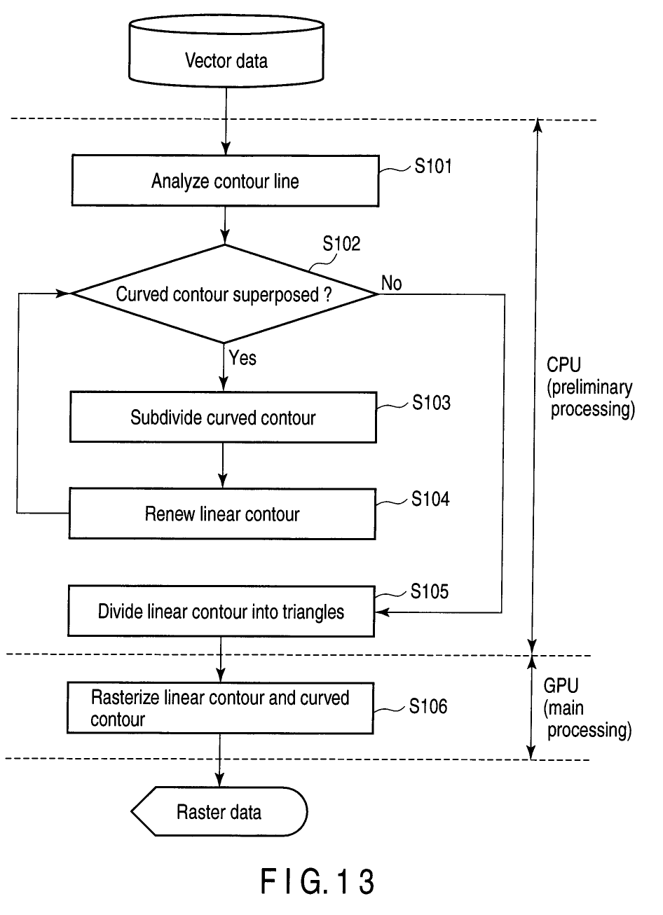

The flowchart of this rasterization operation is shown in FIG. 13. As understood from this flowchart, the process executed using the technique described in JP-A 2006-106705 is roughly divided into two stages, i.e. the preliminary process executed by the CPU and the main process executed by the GPU. First, a pattern of vector type is decomposed into a mass of triangles by CPU, followed by the GPU rasterizing the triangles. The reason why the process is divided into the two stages is that the GPU executes the process in units of triangles and cannot handle the pattern having lines and curves as shown in FIG. 2 directly.

In the first step S101, the data of vector type is read from the storage medium such as HDD or RAM to execute the process of analyzing the contour line. The data of vector type indicating the pattern shown in FIG. 2, for example, is configured of dots and lines as shown in FIG. 3. In FIG. 3, the end points of the lines or the curves of the pattern are indicated by black circles, and the control points of the curves by white circles. In step S101, this data of vector type is analyzed to generate two types of contour line data as shown in FIG. 14.

In this comparative example, the contour line data shown in FIG. 14A is expressed as “linear contour”, and the contour line data shown in FIG. 14B as “curved contour”. To facilitate the understanding, the curved contour shown in FIG. 14B is explained first.

Comparison between FIGS. 2, 3 and 14B shows that the curved contour is a mass of the triangles in which the starting and ending points of curves and control points are connected to each other. Each triangle is circumscribed on the curve which always exists in the triangle.

The curved contour is classified into two types as shown in FIGS. 15A and 15B. In FIG. 15A, the concave area of the curve is located inside the pattern, and FIG. 15B shows that the convex area of the curve is located inside the pattern. In this specification, the former is expressed as the “concave curved contour” and the latter as the “convex curved contour”.

Next, the linear contour shown in FIG. 14A is explained. As understood from the comparison between FIGS. 2, 3 and 14A, the linear contour is a polygon obtained by connecting the starting and ending points of a line, the starting and ending points of a convex curved contour and the starting point and the control point of the concave curved contour by line segments. Take note that the two points including the starting and ending points are connected in the convex curved contour, while the three points including the starting point, the control point and the end point are connected in that order in the concave curved contour.

As understood from FIG. 14A, it is not necessarily only one polygon that forms a linear contour (in the case under consideration, the linear contour is formed of three polygons). Also, each polygon may include a self intersection or hole.

Now, return to the flowchart of FIG. 13. Step S102 checks whether the curved contour generated in the preceding step is superposed or not. In the case where the superposition is found, the control proceeds to step S102 to execute the process of subdividing the larger one of the two superposed triangles.

The linear contour is also changed due to this process, and in the next step S104, the linear contour is renewed. After that, the control is returned to step S102 to check again whether there is a superposition or not. If there is no superposition, the control proceeds to step S105. As long as the curved contour is superposed, the process of steps S102 to S104 is repeated.

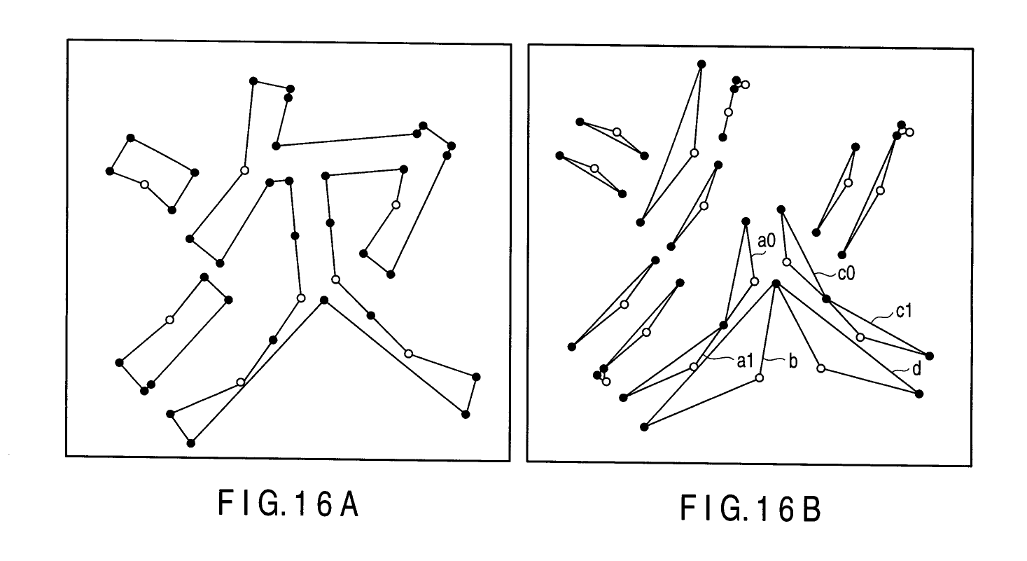

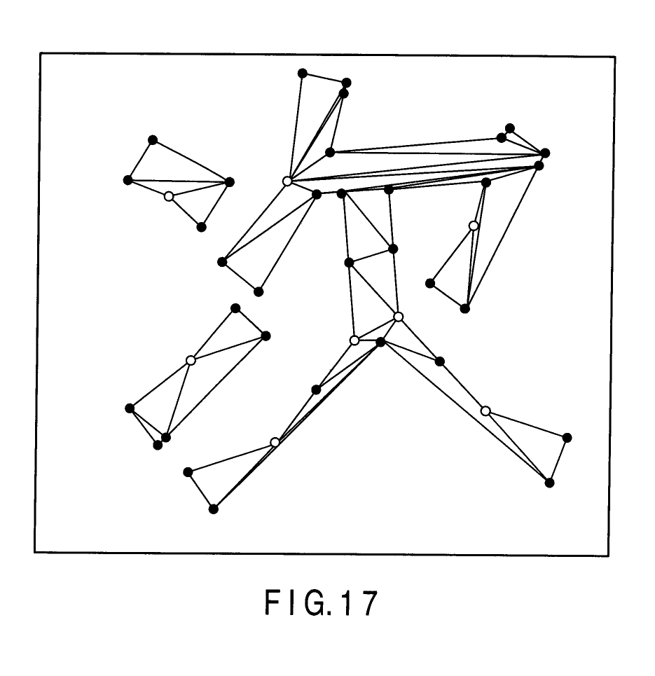

In the curved contour shown in FIG. 14B, for example, step S102 finds that the triangles a and b and the triangles c and d are superposed one on the other. In step S103, on the other hand, the triangles a and c are subdivided into two triangles a0, a1 and c0, c1, respectively, as shown in FIG. 16B. In step S104, the linear contour is renewed as shown in FIG. 16A.

In step S105, each polygon making up the linear contour is divided into triangles. The three polygons shown in FIG. 16A, for example, are divided into a mass of triangles as shown in FIG. 17.

The process (steps S101 to S105) described above is executed in advance by the CPU.

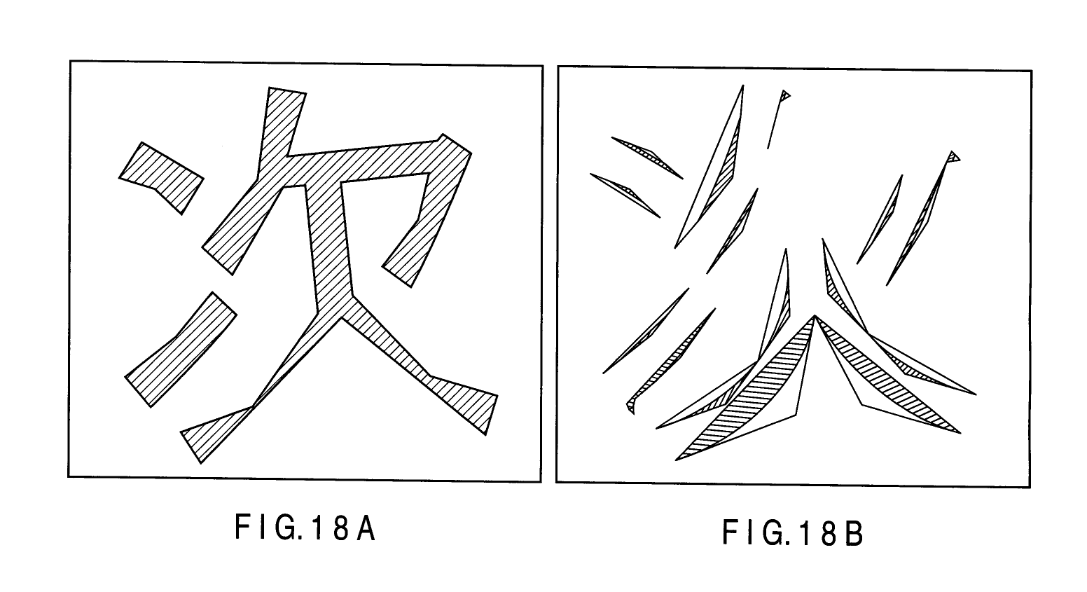

In step S106, the triangles making up the linear contour (FIG. 17) and the triangles making up the curved contour (FIG. 16B) are rasterized by the GPU. In the process, all the pixels located inside the triangles making up the linear contour are rasterized as shown in FIG. 18A.

With regard to the triangles making up the curved contour, on the other hand, as shown in FIG. 18B, only those pixels located inside each triangle which represent the concave area of the concave curved contour or the convex area of the convex curved contour are rasterized.

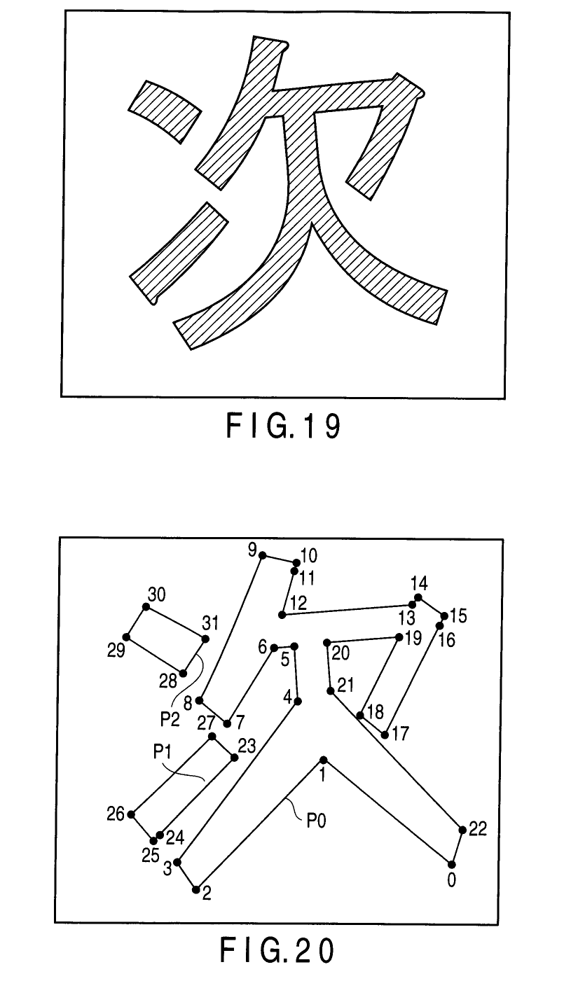

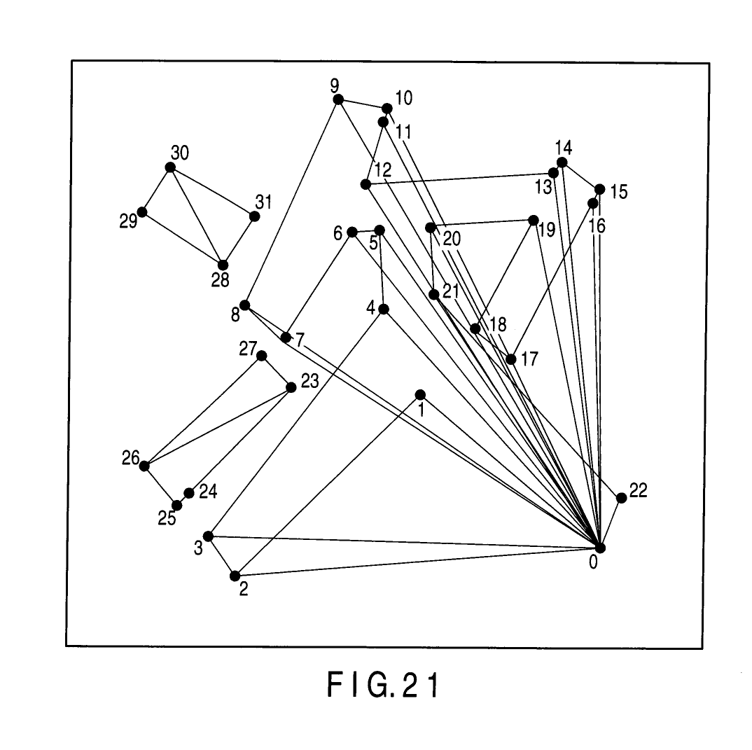

The result of rasterization of the linear contour and the curved contour obtained in this way are stored together in the frame buffer inside the GPU. The rasterization result shown in FIGS. 18A and 18B, for example, is stored in the frame buffer as the raster data as shown in FIG. 19.

In the conventional rasterization method using the GPU, a curve is approximated by use of plural triangles, thereby posing the problem of a coarse appearance when magnified. Also, the only way for smoother rasterization is to improve the approximation accuracy of the curves using a multiplicity of triangles, which unavoidably increases both the storage capacity and the processing cost. According to the method disclosed in JP-A 2006-106705, in contrast, the process is executed not in units of triangles but in units of pixels in the neighborhood of the curved line, and therefore, the curved line can be rasterized always smoothly regardless of the resolution. Further, the storage capacity and the processing cost can always be suppressed without regard to the resolution.

JP-A 2006-106705 described above, however, harbors the two problems explained below.

The first problem is a high preprocessing cost. Especially, the judgment about the superposition of the curved contour in step S102 shown in FIG. 13 and the division of the triangle of the linear contour in step S105 are expensive.

The preprocessing cost is not a great problem as far as the pattern remains unchanged geometrically with time. This is because the preprocessing, once finished, is not required any further. Each time the pattern geometry is changed dynamically, however, the preprocessing has to be repeated, thereby often forming a stumbling block to the rasterization process as a whole.

The second problem is the use of the alpha blend for antialiasing. The “antialiasing” is defined as a process for removing the jaggies (steps) appearing on the contour line of the rasterized pattern. Also, the “alpha blend” is defined as the process of synthesizing two pixel values semi-transparently using the coefficient called the alpha value.

As widely known, the use of the alpha blending requires the sorting of all the patterns with the depth value (depth sorting) to rasterize the patterns sequentially from those located in the deepest position. The depth sorting is a very expensive process and often forms a stumbling block to the rasterization process as a whole.

JP-A 2007-304871 proposes a method to solve these two problems.

According to JP-A 2007-304871, a polygon obtained simply by connecting, with line segments, the starting and ending points of the lines and the curves contained in the vector data is used as a linear contour. The linear contour analyzed from the vector data shown in FIG. 3, for example, make up three polygons P0, P1, P2 as shown in FIG. 20. The curved contour similar to that of JP-A 2006-106705 is used.

One arbitrary point is selected on each polygon making up the linear contour thus formed. In this specification, this point is referred to as a “pivot”. Then, triangles each connecting the pivot and all the two points connected to each other and containing no pivot are formed. The two points connected are defined as those connected by each side of a polygon.

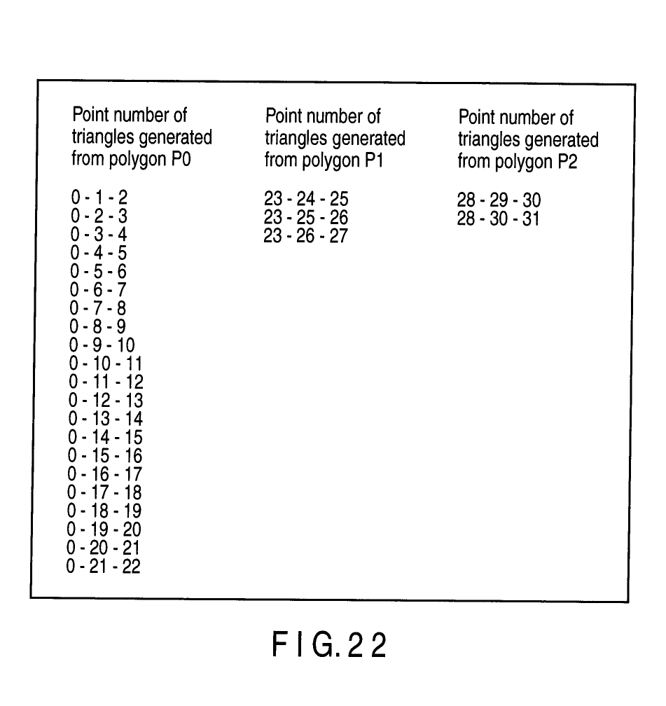

In the case where the points 0, 23, 28 are selected as pivots in the three polygons P0, P1, P2 shown in FIG. 20, for example, the triangles as shown in FIG. 21 are formed. The triangles are superposed, and it is difficult to grasp the triangular shape from this diagram alone. Therefore, the numbers of the three points making up each triangle generated from the three polygons P0, P1, P2 are indicated in FIG. 22.

Incidentally, it should be noted that FIG. 22 is a complementary diagram to facilitate the understanding after all, and not indicative of the triangular data itself. The actual triangular data has the position coordinates of the three points, the texture coordinates and the connection making up each triangle.

Next, the process is executed to generate the stencil data by rasterizing the pixels in the triangles. Incidentally, the stencil data is defined as the image data having the same resolution as the one finally presented.

First, the triangular data of the linear contour and the triangular data of the curved contour are read for rasterization. In the process, all the pixels inside the triangles of the linear contour are rasterized, and the pixel values of the stencil data corresponding to the pixel positions are inverted in bits.

With regard to the triangles of the curved contour, on the other hand, only those pixels located inside each triangle which are associated with the convex area of the curved line are rasterized, and the pixel values of the stencil data corresponding to these pixel positions are inverted in bits.

As a result, the pixel values are inverted in bits an odd number of times inside the pattern, and an even number of times outside the pattern.

The process described above can identify the pixels to be painted, and by painting the pixels corresponding to the raster data for rendering, the rendering result can be generated.

In the technique disclosed in JP-A 2007-304871, the linear contour is not divided into triangles. Even in the case where the vertexes of the vector data are transferred, therefore, the only requirement is to rewrite the corresponding vertex coordinates of the triangular data and the triangular data is not required to be generated again as long a the connection of the triangular data remains unchanged. Therefore, the quick rasterization can be attained even in the case where the pattern geometry changes dynamically.

Also, the antialiasing not requiring the alpha blending is made possible by preparing an image of the raster data with the accuracy on subpixel order for rendering, assigning the color of the pattern to a part of the subpixels based on the coverage data and synthesizing them at the time of finally generating the raster data for rendering.

The techniques described in JP-A 2006-106705 and JP-A 2007-304871, however, is not applicable directly to meet the desire of rendering the pattern on the curved surface.

Generally, the rendering of the polygonal data on the curved surface is realized by adding vertexes in the original polygonal data by dividing the polygonal data into minuscule polygonal data and transferring the particular vertexes. Also in the case where the vector data is rendered on the curved surface using the method disclosed in JP-A 2007-304871, the triangular data generated by the method described in the same patent publication is required to be subdivided.

The triangular data can be subdivided by various methods. Nevertheless, the processing cost is high for carrying out the method to subdivide the triangular data in such a manner as to be considered that the rendering result is sufficiently drawn along the curved surface, i.e. the rendering exact on the curved surface is realized.

Since the triangular data to render the vector data is subdivided, the subdivision process has to be repeated each time the pattern is changed geometrically. Thus, it is impossible to take a satisfactory measure against the dynamic change of the pattern geometry which is both the problem point of JP-A 2006-106705 and the advantage of JP-A 2007-304871.

According to the embodiments of the invention described above, there are provided a rendering apparatus and a rendering method which can avoid the problem described above and execute the quick rendering process without increasing the processing burden of the subdivision or the like even in the case where the vector pattern is rasterized and rendered on the curved surface.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rendering apparatus comprising:
a first storage unit which stores vector data indicating an arbitrary pattern;
a second storage unit which stores a curved surface model as a guide for rendering of the pattern;
a first calculation unit which defines the pattern independently of the curved surface model for each pixel occupied by the curved surface model projected on a screen and which calculates a rendering parameter including a position coordinate, a color information and a transparency in a vector definition space accessed to determine an attribute value of the pixel;
a first generating unit which generates a plurality of primitive data based on one of a linear contour and a curved contour by analyzing the vector data along a contour line;
a third storage unit which stores the plurality of the primitive data in the vector definition space;
a judging unit which judges whether the plurality of the primitive data include the position coordinate, which adds a rendering judgment variable of the position coordinate in the case where the primitive data including the position coordinate is that of the linear contour, and which adds the rendering judgment variable in the case where the primitive data including the position coordinate is that of the curved contour and the position coordinate is included in a convex area of the curved contour; and
a second generating unit which generates the attribute value of the pixel corresponding to the position coordinate based on the rendering parameter in the case where the rendering judgment variable is added an odd number of times.

2. The apparatus according to claim 1,
wherein the vector definition space is a two-dimensional space.

3. The apparatus according to claim 1,
wherein the primitive data is a triangular data.

4. The apparatus according to claim 1,
wherein the primitive data is a convex polygonal data configured of four points or more.

5. The apparatus according to claim 1, further comprising:
a second calculation unit which calculates a shortest distance between the position coordinate and the primitive data; and
an image processing unit which executes image processing including one of a blurring process and a transmission process on the attribute value with the shortest distance as a parameter.

6. The apparatus according to claim 1, further comprising:
a correction unit to deform the primitive data in the third storage unit by an affine transform in accordance with a correction parameter thereby to determine the primitive data after correction, and
wherein the judging unit judges whether the position coordinate is included or not in the primitive data after the correction.

7. The apparatus according to claim 6, further comprising:
an input device which receives a user operation and outputs an input value,
wherein the correction unit determines the correction parameter by processing the input value.

8. The apparatus according to claim 1, further comprising:
a fourth storage unit which stores, for each pixel, the position coordinate and the result of judgment as to whether the position coordinate is included in the primitive data or not;
a fourth calculation unit which specifies a pixel constituting an edge of an image as a rendering result with reference to the judgment information in the fourth storage unit and which calculates a corresponding position for each of subpixels into which an edge pixel is divided into the subpixels, with reference to the position coordinate corresponding to the pixel; and
a fifth calculation unit which judges a drawability of the corresponding position of the subpixels and which calculates coverage data indicating a degree to which a pixel divided into the subpixels can be drawn;
wherein the second generating unit generates an image with the accuracy on subpixel order in such a manner that the subpixels using the color information of an original pixel increase in number with the increase in the size of the coverage data, and synthesizes the subpixel image thereby to generate the attribute value.

9. A rendering method comprising:
storing vector data indicating an arbitrary pattern in a first storage unit;
storing a curved surface model in a second storage unit as a guide to render the pattern;
defining the pattern independently of a curved surface model and calculating, by a first calculation unit, rendering parameters including a position coordinate, a color information and a transparency in a vector definition space accessed to determine a pixel attribute value, for each pixel occupied by the curved surface model at the time of projecting the curved surface model on the screen;
generating, by a first generating unit, a plurality of primitive data based on one of a linear contour and a curved contour by contour line analysis of the vector data;
storing, in a third storage unit, the plurality of the primitive data in the vector definition space;
judging, by a judgment unit, whether the position coordinate is included or not in the plurality of the primitive data, adding a rendering judgment variable of the position coordinate in the case where the primitive data including the position coordinate is that of the linear contour, and adding the rendering judgment variable in the case where the primitive data including the position coordinate is that of the curved contour and the position coordinate is included in the convex area of the curved contour; and
generating, by a second generating unit, the attribute value of the pixel corresponding to the position coordinate based on the rendering parameters in the case where the rendering judgment variable is added an odd number of times.
